(19) United States
(12) Patent Application Publication
(10) Pub. No.: US 2021/0063528 A1
(43) Pub. Date: Mar. 4, 2021

(54) RADAR SENSOR SYSTEM AND METHOD FOR PRODUCING A RADAR SENSOR SYSTEM

(71) Applicant: Robert Bosch GmbH, Stuttgart (DE)

(72) Inventors: Marcel Mayer, Lonsee (DE); Klaus Baur, Mietingen (DE); Michael Schoor, Stuttgart (DE)

(21) Appl. No.: 17/042,075

(22) PCT Filed: Mar. 7, 2019
(86) PCT No.: PCT/EP2019/055697

§ 371 Date: Sep. 25, 2020

(30) Foreign Application Priority Data
May 17, 2018 (DE) 10 2018 207 716.9

(51) Int. Cl. G01S 7/03; G01S 7/00; G01S 7/40; G01S 13/931

(52) U.S. Cl. CPC G01S 7/03; G01S 13/931; G01S 7/4017; G01S 7/003

(57) ABSTRACT

A radar sensor system is described. The radar sensor system includes: at least two HF components each having at least one antenna for transmitting and/or receiving radar waves, and each having at least one antenna controller for operating the at least one antenna. The radar sensor system also includes a synchronization line by way of which the HF components are functionally connected, a length of the synchronization line being such that a detected target is representable in a baseband as a bin pair, the bins of the bin pair being offset from one another by a defined extent.

### FIELD

The present invention relates to a radar sensor system. The present invention further relates to a method for manufacturing a radar sensor system. The present invention further relates to a computer program product.

### BACKGROUND INFORMATION

The market for driver assistance systems is currently experiencing radical change. Whereas in recent years it was primarily inexpensive sensor systems that predominated, the trend now is toward highly autonomous driving, with substantially greater demands on the sensor technology. The greater demands often result in an elevated number of reception and transmission channels. In a time-division multiplexing mode with a predefined total measurement time, however, a large number of transmission channels produces the problem that there is a short measurement time for each switching state, and the signal-to-noise ratio thus drops. One conventional possibility for solving this problem is a frequency-division multiplexing or code-division multiplexing transmitter mode, in which multiple transmitters operate simultaneously. The frequency-division multiplexing method places greater demands on the baseband chain, however, and the code-division multiplexing method produces a limited dynamic range or multiple occupation of the spectrum.

### SUMMARY

An object of the present invention is to furnish a radar sensor system having improved operating characteristics.

According to a first aspect of the present invention, a radar sensor system is provided. In accordance with an example embodiment of the present invention, the radar sensor system includes:
at least two HF components each having at least one antenna for transmitting and/or receiving radar waves, and each having at least one antenna controller for operating the at least one antenna; and
a synchronization line by way of which the HF components are functionally connected,
a length of the synchronization line being such that a detected target is representable in a baseband as a bin pair, the bins of the bin pair being offset from one another by a defined extent.

Advantageously, the bin offset can be used to allow signals from different transmitters to be separated from one another. The result is that angular resolution and angle evaluation are improved, and costs can be reduced by the fact that outlays for code- and frequency-multiplexing devices can be eliminated.

According to a second aspect of the present invention, a method for manufacturing a radar sensor system is provided. In accordance with an example embodiment of the present invention, the method for manufacturing a radar sensor system, includes the steps of:
furnishing at least two HF components each having at least one antenna for transmitting and/or receiving radar waves, and each having at least one antenna controller for operating the at least one antenna; and
furnishing a synchronization line by way of which the HF components are functionally connected, a length of the synchronization line being such that a detected target is representable in a baseband as a bin pair, the bins of the bin pair being offset from one another by a defined extent.

Advantageous refinements of the radar sensor system are described herein.

In an advantageous refinement of the radar sensor system in accordance with the present invention, the bin offset is equal to less than one bin, preferably approximately 0.2 to 0.5 bin.

This affords a good compromise regarding the positional separation capability and angular resolution of the radar sensor system.

In a further advantageous refinement of the radar sensor system in accordance with the present invention, the synchronization line is embodied as a real line. The desired effect of a distance bin offset can thereby be implemented in particularly simple fashion.

In a further advantageous refinement of the radar sensor system in accordance with the present invention, an effect of the synchronization line with regard to bin offset is generatable by way of a single-sideband modulator, transmitted signals of the HF components being shiftable by a specific frequency with respect to one another by way of the single-sideband modulator. The result is to configure a kind of “artificial line,” the result of which is to achieve the same effect as a real line. A frequency offset here is an equivalent of the real line.

In a further advantageous refinement of the radar sensor system in accordance with the present invention, the HF components have a self-powering device that is configured to definably embody the bin offset. The advantageous result thereof is to furnish a further parameter with which the desired bin offset of the distance bins can be even more precisely defined.

In a further advantageous refinement of the radar sensor system in accordance with the present invention, the transmitters separable by way of the bin offset are used for angle evaluation. The advantageous result is that the bin offset can be used to separate the transmitters and thereby to estimate angles.

Preferred exemplifying embodiments of the present invention are explained in further detail below with reference to highly simplified schematic depictions.

### BRIEF DESCRIPTION OF THE DRAWINGS

FIG. 1 schematically depicts a radar sensor system in accordance with an example embodiment of the present invention.

FIG. 2 schematically depicts a further embodiment of a radar sensor system in accordance with the present invention.

FIGS. 3a, 3b schematically depict a manner of operation of the radar sensor system in accordance with an example embodiment of the present invention.

FIG. 4 is a schematic flow chart of a method for manufacturing a radar sensor system in accordance with an example embodiment of the present invention.

In the Figures, the same design elements respectively bear the same reference numbers.

### DETAILED DESCRIPTION OF EXAMPLE EMBODIMENTS

Present-day radar sensors usually have many HF channels for generating and receiving radar waves. In normal operation, all HF modules can be in operation simultaneously.

Because all the HF components are supplied with a fundamental or basic frequency from a common clock, the radar sensor system is highly coherent. In particular, the different HF components can be operated with an identical operating frequency, thereby making possible redundant and coherent clock timing of multiple HF components.

Preferably, at least some of the HF components used in the radar sensor system can be supplied with a clock signal or a fundamental frequency. In normal operation, all the HF components or antenna controllers of the radar sensor system can be supplied with the same clock signal from at least one clock, and all data can therefore be mutually correlated.

In a normal operating mode of the radar sensor system, a clock signal is supplied by at least one clock simultaneously to all antenna controllers or HF components. Because the clock signal is supplied from one source, high coherence of all the HF components in the radar sensor system can be achieved. If a clock has a defect, for example, then at least one further clock for generating an HF signal can be activated or switched in by way of the control unit.

In a radar sensor system, the role of the master (which handles high-frequency generation) is usually assigned to one component, and the other HF components are supplied by it with the HF synchronization signal. The HF synchronization signal is necessary in order to impart high coherence to HF components 10a, . . . , 10d so as to enable high angular resolution for radar sensor system 100. Specialized modules for generating the high frequency, and for further signal processing, are used for this in the existing art.

In a context of continual increases in costs for HF module development, however, for example higher mask costs for smaller node sizes, it is apparent that the use of multiple modules of the same type can offer cost advantages even though the actual silicon area is larger.

What is provided in accordance with an example embodiment of the present invention is that at least two transmitters of a radar sensor system can be operated simultaneously without, for that purpose, increasing a required sampling rate of the A/D converter.

The idea is based in principle on the fact that a target is imaged in a different distance bin depending on the transmitter (if applicable, across HF modules). In conventional multi-MMIC systems, it is always desirable for a target object to be located in the same bin in all MMIC basebands.

A bin offset in the context of detection of a target that is being detected with different transmitted signals of the HF modules makes it possible, however, with no increase in the baseband frequency, for multiple transmitters to be operated simultaneously and for signals to be capable of being separated from one another.

FIG. 1 is a schematic depiction of a radar sensor system 100 provided for this. Radar sensor system 100 has four HF components 10a, . . . , 10d that are embodied as MMICs. The number four is merely an example; the proposed radar sensor system 100 can also have fewer or more than four HF components. Also apparent is a synchronization line 20 to which all HF components 10a, . . . , 10d are functionally connected, and which is used for synchronizing, for instance, an HF operating frequency of all HF components 10a, . . . , 10d.

Radar sensor system 100 furthermore has antenna controllers of HF components 10a, . . . , 10d. In the interest of simplicity, the aforesaid antenna controllers, and further components of HF components 10a, . . . , 10d which are necessary for emitting and receiving radar waves, for example antennas, amplifiers, oscillators, etc., are not depicted.

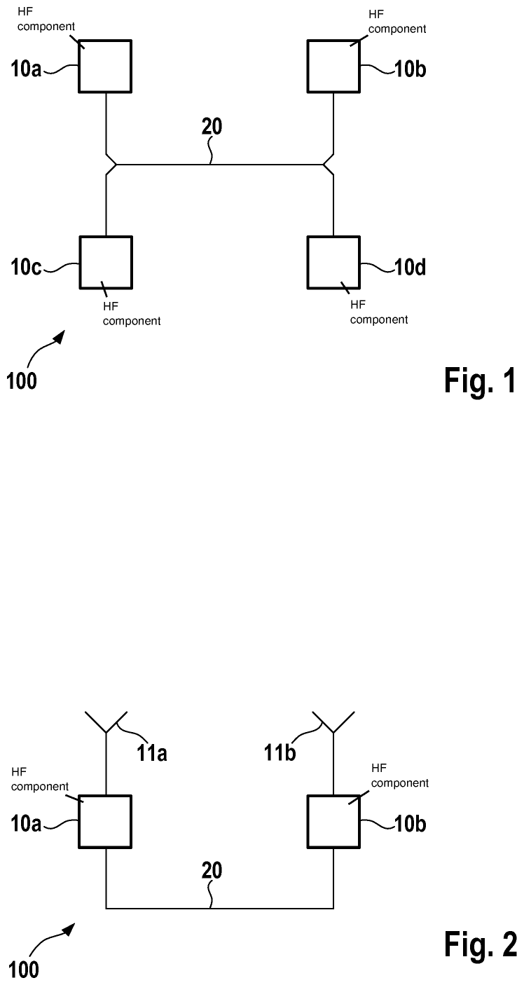

FIG. 2 shows a portion of radar sensor system 100 of FIG. 1, or an independent radar sensor system 100 having two HF components 10a, 10b each having an antenna 11a, 11b, and a synchronization line 20 having a defined physical length I which is dimensioned such that for a detected target object, it results in a distance bin pair (“double peak”), the bins of the bin pair having a defined offset of, for instance, one bin. For a frequency excursion of the transmitters of 1 GHz, synchronization line 20 would need to have an electrical length of 30 cm. If the permittivity of a circuit board (not depicted) is 3, this would be a physical length of approx. 18 cm. For a bandwidth of 4 GHz, the physical length I would correspond to only 4.4 cm.

Advantageously, the bin offset that is aimed for is in a range from approx. 0.1 bin to approx. 1 bin, particularly preferably approx. 0.2 bin, several bins also being permissible as an offset.

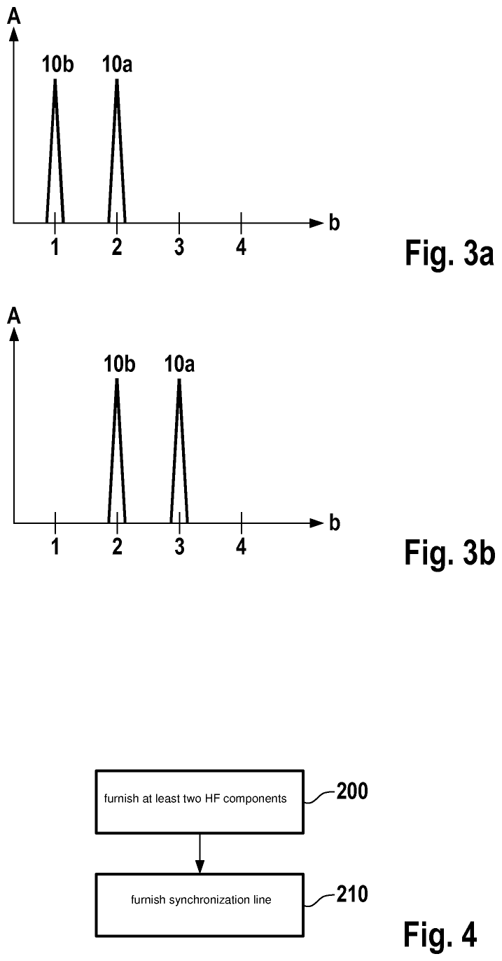

A distinction is made below between two exemplifying cases:
(i) In a first case (depicted in FIG. 3a), HF component 10a transmits and both HF components 10a, 10b receive.
(ii) In a second case (depicted in FIG. 3b), HF component 10b transmits and both HF components 10a, 10b receive.

A baseband of the two HF components 10a, 10b which results therefrom is depicted in simplified fashion in FIGS. 3a and 3b, A denoting the amplitude and b the number of distance bins.

When HF component 10a transmits (case (i)), the signal delivered to the mixers (not depicted) does not experience any additional time delay, with the result that the peak value of the detected target reception signal lies exactly on the expected bin 2 (or on any other expected bin). Synchronization line 20 of HF component 10b, however, produces an offset of the signal of HF component 10b. Because the transmitted signal therefore does not “see” any offset, but the receiving mixer (not depicted) “sees” the HF signal only at a later point in time (because of the length of synchronization line 20), the target detected by radar sensor system 100 appears one bin closer than it would actually be expected to be. In FIG. 3a this would correspond to distance bin 1, or in more generally formulated fashion to the expected distance bin minus 1. The distance bin offset is therefore equal to 1.

When the transmitter switches from HF component 10a to HF component 10b (case (ii)), the baseband picture then changes as depicted in FIG. 3b. It is apparent that in this case the baseband peak value of HF component 10b is located at the expected bin 2. HF component 10a remains the master in this case, however, so that the signal delay produced by synchronization line 20 causes HF component 10a to have the baseband peak at the expected bin plus 1, i.e., at bin 3, as is evident in FIG. 3b. The distance bin offset is therefore equal to 1 in this case as well.

Considering now the superposition of the two aforesaid cases, what results is a baseband in which HF component 10b has a peak value in the target bin and in the target bin minus 1, while HF component 10a has the peak in the target bin and in the target bin plus 1. The result is that a respective transmitting antenna 11a, 11b of the two HF components 10a, 10b can be operated simultaneously, and signals of the two antennas 11a, 11b can be evaluated separately from one another.

This is important for a multiple input multiple output (MIMO) operating mode. The two MIMO transmitting antennas can thus transmit simultaneously, but their phases in the baseband can be evaluated separately.

This type of evaluation can result, disadvantageously, in a degradation in the positional separation capability of the radar sensor system. Advantageously, however, misinterpretations cannot occur, since a bin must always occur pairwise (bin+1/bin−1), in the form of a bin pair, for a detected target.

The example described above describes a bin offset in the form of an integral offset of exactly one bin. That need not obligatorily be the case, however; it is also possible, for instance, for the bin offset to be equal to 0.2 bin from the desired bin. HF ramp signals having different frequency excursions can thereby be used for the transmitted signals of antennas 11a, 11b of HF components 10a, 10b. Because the positional separation capability of radar sensor system 100 becomes worse as the distance between the bins of the bin pair increases, it is desirable to embody the bins of the bin pair at a spacing of approx. 0.2 bin to approx. 0.5 bin.

If the excursion is intended to change greatly from one sequence to the next, for example corresponding to an equivalent of 0.5 bin, a delay line or synchronization line 20 having a fixed electrical length is then unsuitable.

An alternative possibility for generating a time delay from one transmitter to another transmitter in a radar sensor system operated with frequency ramps involves the use of a single-sideband modulator, so as thereby to generate an “artificial” synchronization line 20 that corresponds in terms of effect to a “real,” physically present synchronization line 20.

The signal of one of the transmitters is shifted by a specific frequency by way of the single-sideband modulator, that frequency offset representing an equivalent of the effect of the defined length of synchronization line 20. An advantage of this variant is the ability to implement it in an HF component, and to be able to operate two transmitters of an HF component in parallel.

In a further alternative, the defined delay effect of synchronization line 20 can also be used in a radar sensor system having a self-powering concept, in which a self-powering network or energy-recovery network is implemented for at least one of the HF components.

Provision is made here that HF component 10a, 10d that is capable of feeding in the HF signal (i.e., is “master-capable”), is connected in duplicate to synchronization line 20, which means that a defined feedback of power to the infeeding HF component 10a, 10b occurs. A master-capable HF component 10a, 10d is thus furnished in radar sensor system 100.

The advantageous result of the aforesaid self-powering device is to create a further degree of freedom for dimensioning even more precisely the desired bin offset of the detected target object. Advantageously, the transmitters that can be separated as a result of the bin offset can be used for angle evaluation of the radar sensor system.

Advantageously, the example method can be used not only in a radar sensor system but also in any product having several HF components. The example radar sensor system is preferably used in the automotive sector.

FIG. 4 shows a schematic flow chart of a method for manufacturing a radar sensor system 100 in accordance with an example embodiment of the present invention.

In a step 200, at least two HF components 10a, 10b, each having at least one antenna 11a, 11b for transmitting and/or receiving radar waves, and each having at least one antenna controller for operating the at least one antenna 11a, 11b, are furnished.

In a step 210, a synchronization line 20 by way of which HF components 10a, 10b are functionally connected is furnished, a length of synchronization line 20 being embodied in such a way that a detected target is representable in a baseband as a bin pair, the bins of the bin pair being offset from one another by a defined extent.

In summary, the present invention provides a radar sensor system which has at least two transmitters and with which a line length of a synchronization line is embodied in such a way that an offset between distance bins is generated. That offset is desired and utilized so that signals of the transmitters can be functionally separated from one another, and so that improved operating characteristics for the radar sensor system (e.g., in the form of improved angle evaluation) can thereby be achieved.

One skilled in the art can also, without deviating from the essence of the present invention, implement embodiments that are not described, or are only partly described, above.

1-7. (canceled)

8. A radar sensor system, comprising:
at least two HF components each having at least one antenna for transmitting and/or receiving radar waves, and each having at least one antenna controller configured to operate the at least one antenna; and
a synchronization line by way of which the HF components are functionally connected, wherein a length of the synchronization line is such that a detected target is representable in a baseband as a bin pair, bins of the bin pair being offset from one another by a defined extent.

9. The radar sensor system as recited in claim 8, wherein the bin offset is equal to less than one bin.

10. The radar sensor system as recited in claim 8, wherein the bin offset is 0.2 to 0.5 bin.

11. The radar sensor system as recited in claim 8, wherein the synchronization line is embodied a real line.

12. The radar sensor system as recited in claim 8, wherein an effect of the synchronization line with regard to the bin offset is generated by way of a single-sideband modulator, transmitted signals of the HF components being shifted by a specific frequency with respect to one another by way of the single-sideband modulator.

13. The radar sensor system as recited in claim 8, wherein the HF components have a self-powering device that is configured to definably embody the bin offset.

14. The radar sensor system as recited in claim 8, wherein the transmitters separable by way of the bin offset are used for angle evaluation.

15. A method for manufacturing a radar sensor system, comprising the following steps:
furnishing at least two HF components each having at least one antenna for transmitting and/or receiving radar waves, and each having at least one antenna controller configured to operate the at least one antenna; and
furnishing a synchronization line by way of which the HF components are functionally connected, a length of the synchronization line being such that a detected target is representable in a baseband as a bin pair, bins of the bin pair being offset from one another by a defined extent.
